(19) United States
(12) Patent Application Publication
(10) Pub. No.: US 2008/0027174 A1
(43) Pub. Date: Jan. 31, 2008

(54) STARCH-BASED COATING COMPOSITION

(76) Inventors: Chikara Kawamura, Hiratsuka-shi (JP); Kenichi Umezawa, Hiratsuka-shi (JP); Kouichi Takemoto, Hiratsuka-shi (JP)

Correspondence Address: CHRISTIE, PARKER & HALE, LLP, PO BOX 7068, PASADENA, CA, 91109-7068, US

(21) Appl. No.: 11/777,200

(22) Filed: Jul. 12, 2007

(30) Foreign Application Priority Data
Jul. 31, 2006 (JP) 2006-208654

(51) Int. Cl. C08F 216/06

(52) U.S. Cl. 525/54.26

(57) ABSTRACT

A starch-based coating composition that utilizes naturally derived biodegradable starch and exhibits excellent storage stability as an one-pack lacquer, and that can form coated films with superiority in terms of finished appearance, hardness, adhesion, chemical resistance and alkali resistance. The binder used is a resin (A) obtained by bonding a vinyl polymer onto starch and/or modified starch by graft polymerization, or a resin (C) obtained by reacting the resin (A) with an isocyanate group-containing product (B) obtained by reacting a polyisocyanate compound (b1) with a polyhydric alcohol (b2).

### BACKGROUND OF THE INVENTION

1. Field of the Invention

The present invention relates to a starch-based coating composition. More particularly, the invention relates to a starch-based coating composition that utilizes naturally derived biodegradable starch and exhibits excellent storage stability as a one-pack lacquer, and that can form coated films with superiority in terms of finished appearance, hardness, adhesion, chemical resistance and alkali resistance, as well as to a coated article onto which the coating is applied.

2. Description of the Related Art

Recent years have seen an increased demand for active use of naturally derived, biodegradable raw materials with a low environmental load, from the standpoint of reducing effects on the earth environment by reducing waste treatment and lowering CO₂ emissions.

Typical naturally derived materials include modified starches such as polysaccharide starches or acetylated starches which have conventionally been used in the food and papermaking industries, but recently such starches have come into use as biodegradable plastic materials in the form of products for a wide range of fields including food containers, packaging materials, buffer material sheets, agricultural films, disposable diapers and the like.

Starches have been modified and improved in various ways by chemical modification for utilization as starting materials for industrial products. The basic structure of starch is amylose consisting of α-D-glucose linked in a linear fashion by 1,4-bonds, and modifications such as esterification and etherification utilizing the hydroxyl groups in the structure have been employed since the 1960s.

There has also been proposed urethanated starch wherein at least some of the hydroxyl groups of starch or modified starch have been urethanated by reaction with isocyanate compounds (Japanese Unexamined Patent Publication No. 5-43649).

There has further been proposed a process for production of biodegradable polyurethane by reaction of a polyisocyanate with an organic solvent solution containing at least one type of plant component selected from among starches or modified starches, molasses, polysaccharide-based agricultural wastes and hydroxyl-containing modified vegetable oils (Japanese Unexamined Patent Publication No. 5-186556).

Similarly, bonding of starches and hydroxyl-containing acrylic resins with polyisocyanates has also been proposed (Japanese Unexamined Patent Publication No. 6-65349).

This involves indirect grafting of the “starch resin” and acrylic resin via the polyisocyanate, but several publications have also disclosed methods of direct production of graft starches obtained by radical graft polymerization of unsaturated monomers with starches or modified starches (J. C. Arthur, Jr.; Advan. Macromol. Chem.; “Graft Polymerization onto Polysaccharides”; 2: 1-87(1970), U.S. Pat. No. 3,425,971, U.S. Pat. No. 3,981,100, Japanese Unexamined Patent Publication No. 54-120698, Japanese Unexamined Patent Publication No. 55-90518, Japanese Unexamined Patent Publication No. 56-167746, Japanese Unexamined Patent Publication No. 8-239402).

As examples of combinations of starch with other biodegradable resins, inventions have been disclosed that employ as molding materials different polymer blends comprising combinations of starch or modified starch with cellulose derivatives (Japanese Unexamined Patent Publication No. 6-207047, Japanese Unexamined Patent Publication No. 8-231762).

These prior patents clearly demonstrate that starch-based resins obtained by combining, linking or grafting different polymers are known. However, all of these techniques assume that the uses of the starch-based resins are for structural materials, injection molding materials, sheets and the like, whereas no uses as coatings have been disclosed.

For coating using a starch-based resin, there has been disclosed the use of a reactive curable coating which is a curing agent starch composition comprising a mixture of a starch-based resin and a curing agent having a functional group that complementarily reacts with at least one hydroxyl group in the starch molecule (Japanese Unexamined Patent Publication No. 2004-224887).

There has also been disclosed a water-dispersed resin with a mean particle size of no greater than 1000 nm comprising as a constituent component a copolymer of (A) modified starch and (B) a polymerizable unsaturated monomer, and the use of a water-based coating composition containing the resin, as a reactive curable coating (Japanese Unexamined Patent Publication No. 2006-52338).

However, this starch-based coating technology of the prior art is concerned with reactive curable coatings, whereas a one-pack lacquer type starch-based coating has not yet been developed that exhibits excellent storage stability and is capable of forming a coating film with superior finished appearance, hardness, adhesion, impact resistance, solvent resistance, alkali resistance and chemical resistance.

### BRIEF SUMMARY OF THE INVENTION

It is an object of the present invention to provide a starch-based coating composition that utilizes naturally derived biodegradable starch and exhibits excellent storage stability as an one-pack lacquer, and that can form coated films with superiority in terms of finished appearance, hardness, adhesion, chemical resistance and alkali resistance, as well as to a coated article onto which the coating is applied.

As a result of much diligent research directed toward solving the aforementioned problems of the prior art, the inventors have discovered that they can be solved by using a starch-based resin composition with a specific composition, and have completed the invention based on this discovery.

Specifically, the invention provides the following.

1. A starch-based coating composition characterized by using as the binder a resin (A) obtained by bonding a vinyl polymer onto starch and/or modified starch by graft polymerization.

2. A starch-based coating composition characterized by using as the binder a resin (C) prepared by addition reaction of an isocyanate group-containing product (B) obtained by reacting a polyisocyanate compound (b1) with a polyhydric alcohol (b2), with a resin (A) obtained by bonding a vinyl polymer onto starch and/or modified starch by graft polymerization.

3. A starch-based coating composition according to 1 or 2 above, which further comprises a biodegradable resin.

4. A starch-based coating composition according to any one of 1 to 3 above, which further comprises a wax.

5. A coated article which is coated with a starch-based coating composition according to any one of 1 to 4 above.

The starch-based coating composition of the invention has excellent storage stability and can form coated films with superiority in terms of finished appearance, hardness, adhesion and alkali resistance. The starch-based coating composition is an one-pack type and therefore has excellent manageability (its pot life is not a concern), and because it employs naturally derived, biodegradable starting materials, the total CO₂ emission during the life cycle of the product is minimal and environmental pollution can be reduced.

### DETAILED DESCRIPTION OF THE INVENTION

Preferred modes of the invention will now be explained in detail with the understanding that the invention is not limited only to these modes, and various modifications may be implemented that are within the spirit and scope of the invention.

Resin (A) Obtained By Bonding Vinyl Polymer to Starch and/or Modified Starch By Graft Polymerization

Starch and/or Modified Starch

As examples of useful starches for the invention there may be mentioned unmodified terrestrial stem starches such as corn starch, high amylose starch, wheat starch and rice starch, unmodified subterranean stem starches such as potato starch and tapioca starch, and esterified, etherified, oxidized, acid treated or dextrinated starch-substituted derivatives of these starches. These may be used alone or in combinations of more than one.

Modified starches that are useful for the invention include modified starches comprising aliphatic saturated hydrocarbon groups, aliphatic unsaturated hydrocarbon groups, aromatic hydrocarbon groups and the like bonded by ester bonds and/or ether bonds to starch or starch decomposition products. As starch decomposition products there may be mentioned starch processed by molecular weight-reducing treatment with enzymes, acids or oxidizing agents.

The starches and starch decomposition products preferably have number-average molecular weights in the range of 1,000-2,000,000, more preferably 3,000-500,000 and especially 5,000-200,000, from the viewpoint of film forming properties.

Throughout the present specification, the number-average molecular weight is the value determined according to JIS K0124-83, using TSK GEL4000HXL+G30HXL+G2500HXL+G2000HXL (product of Tosoh Corp.) in a separating column with tetrahydrofuran for GPC as the eluent under conditions with a temperature of 40° C. and a flow rate of 1.0 ml/min, and performing calculation from a chromatogram obtained with an RI refractometer and a calibration curve based on standard polystyrene.

The method of modifying the starch may be ester modification, for example, with the preferred modifying groups being C2-18 acyl groups. The modification may be carried out using a C2-18 organic acid alone or a combination of two or more.

The extent of modification of the modified starch is preferably to a degree of substitution in the range of 0.5-2.8 and especially in the range of 1.0-2.5. A degree of substitution of less than 0.5 will tend to result in insufficient compatibility with the radical polymerizing unsaturated monomer described hereunder, similar to unmodified starch, and will thus lead to an inadequate finished appearance of the formed coating film. On the other hand, a degree of substitution exceeding 2.8 may reduce the biodegradability.

The modified starch is preferably modified to a degree such that its glass transition temperature is below the decomposition temperature of starch (approximately 350° C.) and it is thermoplastic and biodegradable; therefore, when the substituent used for modification has a high carbon number it is preferably modified to a low level (for example, when the substituent is C18 stearyl, the degree of ester substitution is preferably in the range of 0.1-1.8), and when the substituent used for modification has a low carbon number it is preferably modified to a high level (for example, when the substituent is C2 acetyl, the degree of ester substitution is preferably in the range of 1.5-2.8).

The degree of substitution is the average number of hydroxyl groups substituted by the modifying agent per monosaccharide unit of the starch. There are three hydroxyl groups per monosaccharide unit, and for example, a degree of substitution of 3 means that all of the three hydroxyl groups per monosaccharide unit of the starch are substituted with the modifying agent, while a degree of substitution of 1 means that only one of the three hydroxyl groups per monosaccharide unit of the starch is substituted with the modifying agent.

As examples of modified starches there may be mentioned hydrophobic biodegradable starch ester products obtained by mixing anhydrous starch with an amylose content of 50% or greater with an esterifying agent in an aprotic solvent to allow reaction between the starch and esterifying agent (see Japanese Patent Public Inspection No. 8-502552).

There may also be mentioned short chain/long chain mixed starch esters wherein reactive hydroxyl group hydrogen atoms of the same starch molecule are substituted with C2-4 short-chain acyl groups and C6-18 long-chain acyl groups (see Japanese Unexamined Patent Publication No. 2000-159801), and short chain/long chain mixed starch substituted derivatives wherein reactive hydroxyl groups of the same starch molecule are substituted with C2-4 short-chain hydrocarbon-containing groups and C6-24 long-chain hydrocarbon-containing groups (see Japanese Unexamined Patent Publication No. 2000-159802). Because these modified starches are based on starch, they are biodegradable and have very good solubility and compatibility in solvents.

Graft polymerization of vinyl polymer The resin (A) is produced by graft polymerization of a vinyl polymer onto the aforementioned starch and/or modified starch. For example, U.S. Pat. No. 3,425,971, U.S. Pat. No. 3,981,100 and Japanese Unexamined Patent Publication No. 56-167746 disclose graft polymerization of vinyl monomers onto water-dispersed or slurry-like starches or modified starches using cerium salts as radical polymerization initiating catalysts. Also, Japanese Unexamined Patent Publications No. 54-120698 and 55-90518 disclose graft polymerization of styrene and acrylic monomers onto starches modified with maleic acid as an unsaturated group-containing compound. Japanese Unexamined Patent Publication No. 8-239402 discloses graft polymerization of a vinyl monomer onto (vinyl) esterified starch in an organic solvent. In addition, Japanese Unexamined Patent Publications No. 55-133472 and 56-157463 disclose graft polymerization of vinyl-based monomers onto cellulose acetate butyrate in solution using radical initiators. If cellulose acetate butyrate is substituted with starch and/or modified starch, it becomes easy to bond vinyl polymers to the starch and/or modified starch by graft polymerization.

Several types of graft polymerization are known for vinyl polymers, and resin (A) can be produced by such known methods. It can also be produced by methods other than those already known.

Vinyl polymers that are bonded to starch and/or modified starch by graft polymerization are obtained by radical polymerization of a radical-polymerizing unsaturated monomer or its mixture in the presence of starch and/or modified starch, an organic solvent and a polymerization initiator.

There are no particular restrictions on the ratio of the starch and/or modified starch with respect to the vinyl polymer, but it is preferred to use a mixture of monomers with different properties as radical-polymerizing unsaturated monomers, while from the standpoint of forming a coated film with excellent finished appearance, adhesion, solvent resistance, alkali resistance, impact resistance and flex resistance, it is preferably a radical-polymerizing unsaturated monomer mixture (c) comprising 1-90 mass % and preferably 5-80 mass % of an aromatic monomer, 1-50 mass % and preferably 2-40 mass % of a hydroxyl-containing monomer and 0-98 mass % and preferably 47-95 mass % of another monomer, with respect to the total mass of the mixture.

As examples of aromatic monomers there may be mentioned styrene, vinyltoluene, 2-methylstyrene, tert-butylstyrene, chlorstyrene, vinylnaphthalene and the like.

As hydroxyl-containing monomers there may be mentioned C₂-C₈hydroxyalkyl esters of acrylic acid or methacrylic acid, such as 2-hydroxyethyl acrylate, 2-hydroxyethyl methacrylate, hydroxypropyl acrylate, hydroxypropyl methacrylate, 4-hydroxybutyl acrylate, 4-hydroxybutyl methacrylate, 2-hydroxypropyl methacrylate and 3-hydroxypropyl methacrylate, and other hydroxyl group-containing (meth)acryl acid ester monomers such as the PLACCEL F series by Dicel Chemical Industries, Ltd. (lactone-modified (meth)acrylic acid ester).

Preferred is at least one compound selected from the group consisting of 2-hydroxyethyl acrylate, 2-hydroxyethyl methacrylate, hydroxypropyl acrylate, hydroxypropyl methacrylate and 4-hydroxybutyl acrylate, from the standpoint of improving compatibility with the starch and/or modified starch or the isocyanate group-containing compound (B), to ensure stability of the coating.

As other monomers there may be mentioned carboxyl group-containing monomers such as (meth)acrylic acid, maleic acid, crotonic acid, itaconic acid and fumaric acid; C1-18 alkyl esters or cycloalkyl esters of acrylic acid or methacrylic acid such as methyl acrylate, ethyl acrylate, n-propyl acrylate, isopropyl acrylate, n-acrylate, i- or t-butyl, hexyl acrylate, 2-ethylhexyl acrylate, n-octyl acrylate, decyl acrylate, lauryl acrylate, cyclohexyl acrylate, methyl methacrylate, ethyl methacrylate, n-propyl methacrylate, isopropyl methacrylate, n-methacrylate, i- or t-butyl, hexyl methacrylate, octyl methacrylate, decyl methacrylate, lauryl methacrylate and cyclohexyl methacrylate; and N-substituted acrylamide-based or N-substituted methacrylamide-based monomers such as N-methylolacrylamide, N-butoxymethylacrylamide, N-methoxymethylacrylamide, N-methylolmethacrylamide and N-butoxymethylmethacrylamide, while polymerizable unsaturated monomers may include fatty acid-modified polymerizable unsaturated monomers as portions thereof. Fatty acid-modified polymerizable unsaturated monomers include polymerizable unsaturated monomers having polymerizable unsaturated groups at the ends of fatty acid-derived hydrocarbon chains. As examples of fatty acid-modified polymerizable unsaturated monomers there may be mentioned those obtained by reacting fatty acids with epoxy group-containing polymerizable unsaturated monomers or hydroxyl group-containing polymerizable unsaturated monomers.

As fatty acids there may be mentioned drying oil fatty acids, semidrying oil fatty acids and non-drying oil fatty acids, among which examples of drying oil fatty acids and semi-drying oil fatty acids include fish oil fatty acids, dehydrated castor oil fatty acids, safflower oil fatty acids, linseed oil fatty acids, soybean oil fatty acids, sesame oil fatty acids, poppy oil fatty acids, perilla oil fatty acids, hempseed oil fatty acids, grape seed oil fatty acids, corn oil fatty acids, tall oil fatty acids, sunflower oil fatty acids, cottonseed oil fatty acids, walnut oil fatty acids, gum oil fatty acids and high-dienoic acid-containing fatty acids, and examples of non-drying oil fatty acids include coconut oil fatty acids, hydrogenated coconut oil fatty acids and palm oil fatty acids. These may be used alone or in combinations of two or more. These fatty acids may also be used in combination with caproic acid, capric acid, lauric acid, myristic acid, palmitic acid, stearic acid and the like.

Preferred monomers that can react with the aforementioned fatty acids to produce fatty acid-modified polymerizable unsaturated monomers include epoxy group-containing polymerizable unsaturated monomers, and as examples there may be mentioned glycidyl(meth)acrylate, β-methylglycidyl(meth)acrylate, 3,4-epoxycyclohexylmethyl (meth)acrylate, 3,4-epoxycyclohexylethyl(meth)acrylate, 3,4-epoxycyclohexylpropyl(meth)acrylate and allylglycidyl ether.

The vinyl monomer graft polymerization can be easily accomplished by, for example, adding the aforementioned radical-polymerizing unsaturated monomer mixture and polymerization initiator dropwise to an organic solvent solution of the starch and/or modified starch for radical polymerization reaction. A mixture of the radical-polymerizing unsaturated monomer mixture and polymerization initiator may be evenly added dropwise and reaction conducted, for example, for approximately 30 minutes to 6 hours and preferably 1-5 hours at a reaction temperature of 60-200° C. and preferably 80-180° C.

The polymerization initiator used may be a known radical polymerization initiator, but a peroxide-based initiator is preferably used when employing a method of graft polymerization by dropwise addition of the monomer mixture and polymerization initiator to an organic solvent solution of the starch and/or modified starch. As examples of such peroxide-based initiators there may be mentioned hydroperoxides such as t-butyl hydroperoxide, p-methane hydroperoxide, cumene hydroperoxide and diisopropylbenzene hydroperoxide; peroxy esters such as t-butylperoxy laurate, t-butylperoxy benzoate and t-butylperoxy decanoate; peroxyketals such as 1,5-di-t-butylperoxy-3,3,5-trimethylcyclohexane; ketone peroxides such as ethyl acetoacetate peroxide and diacyl peroxides such as benzoyl peroxide.

The organic solvent used may be, for example, a hydrocarbon-based solvent such as toluene, xylene, cyclohexane or n-hexane, an ester-based solvent such as methyl acetate, ethyl acetate or butyl acetate, a ketone-based solvent such as acetone, methyl ethyl ketone, methyl isobutyl ketone or methyl amyl ketone, or a mixture of the above.

Isocyanate Group-containing Product (B)

The isocyanate group-containing compound (B) may be obtained by reacting a polyisocyanate compound (b1) with a polyhydric alcohol (b2).

The polyisocyanate compound (b1) is preferably one that is highly safe for the human body, and as examples there may be mentioned isophorone diisocyanate, tolylene diisocyanate, diphenylmethane diisocyanate, tolidine diisocyanate, naphthalene diisocyanate, triphenylmethane triisocyanate, tris(phenylisocyanato)thiophosphate, phenylene diisocyanate, hexamethylene diisocyanate, trimethylhexamethylene diisocyanate, lysine diisocyanate, xylylene diisocyanate, bis(isocyanatomethyl)cyclohexane, bis(isocyanato)methylcyclohexane, dicyclohexylmethane diisocyanate, isopropylidenebis(cyclohexylisocyanate), 3-(2′-isocyanatocyclohexyl)propyl isocyanate, dianisidine diisocyanate and diphenyl ether diisocyanate. Preferred among these are isophorone diisocyanate and hexamethylene diisocyanate from the standpoint of hardness, adhesion and impact resistance.

As examples of commercially available products for polyisocyanate compound (b1) there may be mentioned BURNOCK D-750, D-800, DN-950, DN-970 or 15-455 (product names of Dainippon Ink and Chemicals, Inc.), DESMODUR L, N, HL or N3390 (product names of Bayer Ltd., Germany), TAKENATE D-102, TAKENATE D-170HN, TAKENATE D-202, TAKENATE D-110 or TAKENATE D-123N (product names of Takeda Pharmaceutical Co., Ltd.), Coronate EH, L, HL or 203 (product names of Nippon Polyurethane Industry Co., Ltd.) or DURANATE 24A-90CX (product name of Asahi Kasei Corp.).

As the polyhydric alcohol (b2) there may be mentioned, specifically, alkylenediols (b21), trihydric or greater alkylenetriols (b22), ether polyols (b23) and polyester polyols (b24), as well as other polyols.

As examples of alkylenediols (b21) there may be mentioned diols such as ethylene glycol, propylene glycol, 1,3-butylene glycol, 1,4-butanediol, 1,5-pentanediol, 1,6-hexanediol, cyclohexane-1,4-dimethylol, neopentyl glycol, methylpentanediol, hydrogenated bisphenol A and the like.

As trihydric or greater alkylene polyols (b22) there may be mentioned triols such as glycerol, trimethylolethane and trimethylolpropane, and tetrahydric or greater alkylene polyols such as pentaerythritol, α-methyl glycoside and sorbitol.

As examples of ether polyols (b23) there may be mentioned polyethylene glycol, polypropylene glycol, polytetramethylene glycol, triethylene glycol, poly(oxyethylene/oxypropylene)glycol, bisphenol A-polyethylene glycol ether, bisphenol A-polypropylene glycol ether, sucrose and hexols such as dipentaerythritol, which are produced by ring-opening addition reaction of alkylene oxides (for example, ethylene oxide, diethylene glycol, propylene oxide, dipropylene glycol, butylene oxide, tetrahydrofuran and the like).

As examples of polyester polyols (b24) there may be mentioned polyols obtained by polycondensation reaction between an organic dicarboxylic acid or its anhydride with an organic diol component, in an excess of the organic diol. Specifically, there may be mentioned polyester polyols that are adipic acid and ethylene glycol condensation products or adipic acid and neopentyl glycol condensation products.

The organic dicarboxylic acid used in this case is a C2-44 and especially C4-36 aliphatic, alicyclic or aromatic dicarboxylic acid, and as examples there may be mentioned succinic acid, adipic acid, azelaic acid, sebacic acid, maleic acid, fumaric acid, glutaric acid, hexachloroheptanedicarboxylic acid, cyclohexanedicarboxylic acid, o-phthalic acid, isophthalic acid, terephthalic acid, tetrahydrophthalic acid, tetrachlorophthalic acid and the like. In addition to these dicarboxylic acids, there may also be included small amounts of polycarboxylic anhydrides or unsaturated fatty acid addition products with three or more carboxyl groups. As examples of organic diol components there may be mentioned alkylene glycols such as ethylene glycol, propylene glycol, butylene glycol, 1,4-butanediol, 1,6-hexanediol and neopentyl glycol, or dimethylolcyclohexane, butylethylpentyl glycol, methylpentanediol and the like, which may be used in combination with small amounts of trihydric or greater polyols such as trimethylolpropane, glycerol or pentaerythritol as appropriate.

Among the polyhydric alcohols (b2) mentioned above there may be mentioned as particularly suitable, from the standpoint of impact resistance and flex resistance, those selected from the group consisting of ethylene glycol, propylene glycol, 1,4-butanediol, 1,6-hexanediol, diethylene glycol, triethylene glycol, hydrogenated bisphenol A, glycerin, trimethylolethane, trimethylolpropane, pentaerythritol, dipentaerythritol, polyethylene glycol, polypropylene glycol, polytetramethylene glycol, poly(oxyethylene/oxypropylene)glycol, bisphenol A-ethylene glycol ether and bisphenol A-polypropylene glycol ether.

The reaction between the polyisocyanate compound (b1) and polyhydric alcohol (b2) may be carried out in an organic solvent (for example, a hydrocarbon-based solvent such as toluene, xylene, cyclohexane or n-hexane; an esteric solvent such as methyl acetate, ethyl acetate or butyl acetate, a ketone-based solvent such as acetone, methyl ethyl ketone, methyl isobutyl ketone or methyl amyl ketone, or a mixture of the above), mixing the polyisocyanate compound (b1) and polyhydric alcohol (b2) in amounts such that the number of moles of OH groups of the polyhydric alcohol (b2) with respect to the number of moles of NCO groups of the polyisocyanate compound (b1) is NCO/OH=1/0.4-1/0.95 and preferably 1/0.5-1/0.9, as the reaction ratio of the polyisocyanate compound (b1) and polyhydric alcohol (b2) in order to leave free isocyanate groups, optimally with addition of a catalyst such as monobutyltin oxide or dibutyltin oxide, for example, while stirring at a temperature of between about 50° C. and about 200° C. and preferably about 60-150° C. for a period as long as between 30 minutes and 10 hours and preferably about 1-5 hours, in order to produce a solution of an isocyanate group-containing product (B). The NCO value of the resulting isocyanate group-containing product (B) is preferably in the range of 5-250 mgNCO/g and especially in the range of 7-200 mgNCO/g.

Resin (C) Obtained By Reacting Isocyanate Group-containing Product (B) with Resin (A) Comprising a Vinyl Polymer Bonded to Starch and/or Modified Starch By Graft Polymerization

Resin (C) is prepared by addition reaction of the isocyanate group-containing product (B) obtained by reacting a polyisocyanate compound (b1) with a polyhydric alcohol (b2), with the resin (A) obtained by bonding a vinyl polymer to starch and/or modified starch by graft polymerization. The resin (A) and the isocyanate group-containing product (B) may be appropriately selected for the desired film performance.

According to the invention, resin (C) may be obtained by mixing 50-99 mass % and preferably 60-98 mass % of resin (A) and 1-50 mass % and preferably 2-40 mass % of the isocyanate group-containing product (B) based on the total solid mass of the resin (A) and the isocyanate group-containing product (B), in an organic solvent (for example, a hydrocarbon-based solvent such as toluene, xylene, cyclohexane or n-hexane; an esteric solvent such as methyl acetate, ethyl acetate or butyl acetate; a ketone-based solvent such as acetone, methyl ethyl ketone, methyl isobutyl ketone or methyl amyl ketone; or a mixture of the above) and conducting addition reaction while stirring at a temperature of between about 50° C. and about 200° C. and preferably 60-150° C., for a period of between 30 minutes and 10 hours and preferably 1-5 hours, optimally with addition of a catalyst such as monobutyltin oxide or dibutyltin oxide. From the viewpoint of film formability, the obtained resin (C) preferably has a number-average molecular weight in the range of 3,000-2,000,000 and especially in the range of 5,000-100,000.

The resin (C) produced in this manner may be suitably used as a starch-based coating binder dissolved or dispersed in an organic solvent-based medium.

Biodegradable Resin

The starch-based coating composition of the invention may also contain another biodegradable resin. As examples of known marketed biodegradable resins other than starch-based resins there may be mentioned plant fibers (cellulose resins), polyhydroxycarboxylic acids such as polylactic acid, or polycaprolactam, modified polyvinyl alcohols and the like. Aliphatic polyesters such as polycaprolactone are also biodegradable. A large number of biodegradable resins other than those mentioned above are also known. According to the invention, any biodegradable resin that is soluble in the solvent may be used, although cellulose resins are preferred.

Nitrocellulose and cellulose acetate butyrate (a modified cellulose) are widely used in the coating industry as lacquer binders or modifying additive resins. According to the invention as well, addition of a small amount of nitrocellulose and/or cellulose acetate butyrate improves the drying property of the coated film when it is used as an one-pack type lacquer coating, and increases the surface hardness. Although an effect of increased surface hardness was also found with polyhydroxycarboxylic acids and particularly polylactic acid, they tended to produce friable coating films, whereas cellulose-derived resins resulted in a better balance of film performance and easier use. As nitrocelluloses that may be suitably used for the invention, there may be mentioned the industrial nitrocellulose BNC-HIG-2 (product of Bergerac NC, France), the industrial nitrocellulose RS1-4 (product of CNC, South Korea), SwanCel HM1-4 (product of Hyupseon Corp.) and Sernova BTH1-4 (product of Asahi Kasei Corp.), and as cellulose acetate butyrate products there may be mentioned CAB381-0.1, CAB381-0.5, CAB381-2, CAB531-1, CAB551-0.01 and CAB551-0.2 (products of Eastman Chemical Products).

The contents of these biodegradable resins are preferably no greater than 50 parts by mass and even more preferably no greater than 35 parts by mass, based on 100 as the total of the starch-based resin as the main binder, and the biodegradable resin. If the content is greater than 50 parts by mass, the film formability of the coating will be insufficient, and the finished appearance and chemical resistance will be outside of practical ranges.

Starch-based Coating

The starch-based coating composition of the invention can be used in conventionally known liquid coating systems, such as water-based paints, organic solvent-based coatings and the like. Such systems using diluting solvents such as, for example, hydrocarbon-based organic solvents such as toluene, xylene, cyclohexane and n-hexane, esteric organic solvents such as methyl acetate, ethyl acetate and butyl acetate, and ketone-based organic solvents such as acetone, methyl ethyl ketone, methyl isobutyl ketone and methyl amyl ketone, either alone or in combinations of two or more, as organic solvent-type coatings, are very manageable coatings with excellent ease of coating as lacquers, and high drying speeds.

Natural dyes, organic synthetic dyes or pigments, inorganic pigments and effect pigments may also be used if necessary as coloring components in the starch-based coating.

As natural dyes there may be mentioned, specifically, carotenoids such as carotene, carotenal, capsanthin, lycopene, bixin, crocin, canthaxanthin and annatto, flavonoids including anthocyanidins such as shisonin, raphanin and enocyanine, chalcones such as safrole yellow and safflower, flavonols such as rutin and quercetin and flavones such as cacao dyes, flavins such as riboflavin, quinones including anthraquinones such as laccaic acid, carminic acid (cochineal), kermesic acid and alizarin and naphthoquinones such as shikonin, alkannin and echinochrome, porphyrins such as chlorophyll and hemoglobin, diketones such as curcumin (turmeric), and betacyanidins such as betanin.

As organic synthetic dyes and pigments there may be mentioned those prescribed by Health and Welfare Ministry Ordinance No. 30. For example, there may be mentioned Red #202 (lithol rubin BCA), Red #203 (lake red C), Red #204 (lake red CBA), Red #205 (lithol red), Red #206 (lithol red CA), Red #207 (lithol red BA), Red #208 (lithol red SR), Red #219 (brilliant lake red R), Red #220 (deep maroon), Red #221 (toluidine red), Red #228 (permaton red), Orange #203 (permanent orange), Orange #204 (bentizine orange G), Yellow #205 (bentizine yellow G), Red #404 (brilliant fast scarlet), Red #405 (permanent red F5R), Orange #401 (hansa orange), Yellow #401 (hansa yellow), Blue #404 (phthalocyanine blue), and the like.

As inorganic pigments there may be mentioned silicic anhydride, magnesium silicate, talc, kaolin, bentonite, zirconium oxide, magnesium oxide, zinc oxide, titanium oxide, light calcium carbonate, heavy calcium carbonate, light magnesium carbonate, heavy magnesium carbonate, barium sulfate, iron oxide yellow, iron oxide red, iron oxide black, ultramarine, chromium oxide, chromium hydroxide, carbon black, calamine and the like.

An effect pigment is a scaly pigment that imparts a shiny bright appearance or light interfering property to a coating film, and as examples there may be mentioned scaly aluminum flake, vapor deposited aluminum flake, aluminum oxide, oxybismuth chloride, mica, titanium oxide-coated mica, iron oxide-coated mica, micaceous iron oxide, titanium oxide-coated silica, titanium oxide-coated alumina, iron oxide-coated silica, iron oxide-coated alumina, glass flakes, colored glass flakes, vapor deposited glass flakes, hologram films, and the like. The sizes of such brightening materials are preferably 1-30 μm in the lengthwise direction and 0.001-1 μm in thickness.

The mixing proportion of the coloring components may be appropriately determined for the intended use and the desired performance, but normally it will be in the range of 0.001-400 parts by mass and preferably 0.01-200 parts by mass as the total of the coloring components with respect to 100 parts by mass of the starch-based resin composition.

If necessary, conventionally known surface control agents (waxes, anticissing agents, antifoaming agents, etc.), plasticizers, ultraviolet stabilizers, antioxidants, fluidity adjustors, antidrip agents, delustering agents, polishing agents, antiseptic agents and the like may be used in the starch-based coating.

Addition of waxes has a notable effect for improving the finished appearance and chemical resistance. According to the invention there may be used any waxes that are conventionally added to coatings. As examples of such waxes there may be mentioned fatty acid ester waxes that are esterified products of polyol compounds and fatty acids, silicon-based waxes, fluorine-based waxes, polyolefin waxes, animal waxes, plant waxes and the like, among which one or more selected from among polyethylene-based waxes, silicon-based waxes and fluorine-based waxes are preferred.

These waxes may be used alone or in combinations of two or more, and their addition is preferably in the range of 0.1-10 parts by mass and especially 0.5-3 parts by mass with respect to 100 parts by mass as the total of the starch-based resin binder and the optionally added biodegradable resin.

A coated article of the invention is obtained by coating the surface of a base material with a coating composition of the invention. The base material to be coated with the starch-based coating composition is not particularly restricted, and as examples there may be mentioned metals, plastics, glass, ceramics, concrete, paper, fibers, wood materials, plant substances, stone, sand and the like.

The starch-based coating of the invention may be used for coating or printing by roller painting, brush painting, dip painting, spray coating (non-electrostatic coating, electrostatic coating or the like), curtain flow painting, screen printing or relief printing.

After drying the coated film for 1-40 minutes at below 100° C., it is allowed to stand at raised temperature (50° C. or above) for at least 10 hours, or at ordinary temperature (50° C. or below) for 1-7 days for volatilization of the solvent (and/or water) in the coated film to form a continuous coated film. If necessary, drying may be performed at 100-200° C. for between 30 seconds and 120 minutes, and preferably at 100-120° C. for 2-30 minutes.

The coated film thickness is not particularly restricted, but the dry film thickness will generally be about 1-200 μm on average, and is particularly preferred to be 2-100 μm and especially 5-50 μm.

The invention will now be explained in greater detail using examples and comparative examples, with the understanding that the invention is in no way limited in scope by the examples. The “parts” and “%” values referred to throughout are “parts by mass” and “mass %”.

Production of Modified Starch

After suspending 25 parts of high amylose corn starch (product of Nihon Cornstarch Corp., hydroxyl value: 500 mgKOH/g) in 200 parts of dimethylsulfoxide (DMSO), the mixture was heated to 90° C. while stirring and the temperature was maintained for 20 minutes for gelatinization. To this solution there was added 20 parts of heavy sodium carbonate as a catalyst, and then 17 parts of vinyl laurate was added while maintaining the temperature of 90° C., and reaction was conducted for one hour at that temperature. Next, 37 parts of vinyl acetate was added and reaction was continued at 80° C. for 1 hour. The reaction solution was then poured into tap water, and the mixture was stirred at high speed for disintegration and then filtered and dewatered to prepare modified starch 1.

### PRODUCTION EXAMPLE 1

### Polymer-bonded Modified Starch Resin 1 Solution

In a 1 L reactor equipped with a thermometer, thermostat, stirrer, condenser and dropping apparatus and there was charged 466 parts of butyl acetate, and the mixture was heated to 50° C. while stirring under a nitrogen atmosphere. Next, 160 parts of modified starch 1 was charged into the reactor while maintaining a temperature of 50° C., after which the temperature was raised to 100° C. and the mixture was stirred until complete dissolution of the charged modified starch 1.

A solution of “mixture 1” having the composition listed below was added dropwise over a period of 1 hour, and upon completion of the dropwise addition, the mixture was aged at 100° C. for 1 hour to obtain a solution of modified starch resin 1 with a resin solid content of 30%.

“Mixture 1”

| | |
|---|---|
| Styrene | 32 parts |
| Methyl methacrylate | 4 parts |
| n-Butyl acrylate | 4 parts |
| PARCADOX CH-50L (*1) | 4 parts |

(*1): Containing polymerization initiator and 50% diacyl peroxide: product of Kayaku Akzo Corp.

### PRODUCTION EXAMPLE 2

### Polymer-bonded Modified Starch Resin 2 Solution

The procedure of Production Example 1 was repeated, except for using a solution of “mixture 2” having the composition listed below instead of the solution of “mixture 1”, to obtain a solution of modified starch resin 2 with a resin solid content of 30%.

“Mixture 2”

| | |
|---|---|
| Styrene | 28 parts |
| Methyl methacrylate | 4 parts |
| n-Butyl acrylate | 4 parts |
| 2-Hydroxyethyl methacrylate | 4 parts |
| PARCADOX CH-50L | 4 parts |

### PRODUCTION EXAMPLE 3

### Polymer-bonded Modified Starch Resin 3 Solution

The procedure of Production Example 1 was repeated, except for using a solution of “mixture 3” having the composition listed below instead of the solution of “mixture 1”, to obtain a solution of modified starch resin 3 with a resin solid content of 30%.

“Mixture 3”

| | |
|---|---|
| Styrene | 16 parts |
| Methyl methacrylate | 16 parts |
| n-Butyl acrylate | 4 parts |
| 2-Hydroxyethyl methacrylate | 4 parts |
| PARCADOX CH-50L | 4 parts |

### PRODUCTION EXAMPLE 4

### Polymer-bonded Modified Starch Resin 4 Solution

The procedure of Production Example 1 was repeated, except that modified starch 1 was charged in an amount of 180 parts and a solution of “mixture 4” having the composition listed below was used instead of the solution of “mixture 1”, to obtain a solution of modified starch resin 4 with a resin solid content of 30%.

“Mixture 4”

| | |
|---|---|
| Styrene | 14 parts |
| Methyl methacrylate | 2 parts |
| n-Butyl acrylate | 2 parts |
| 2-Hydroxyethyl methacrylate | 2 parts |
| PARCADOX CH-50L | 2 parts |

### PRODUCTION EXAMPLE 5

### Polymer-bonded Modified Starch Resin 5 Solution

The procedure of Production Example 1 was repeated, except for using a solution of “mixture 5” having the composition listed below instead of the solution of “mixture 1”, to obtain a solution of modified starch resin 5 with a resin solid content of 30%.

“Mixture 5”

| | |
|---|---|
| Methyl methacrylate | 32 parts |
| n-Butyl acrylate | 4 parts |
| PARCADOX CH-50L | 4 parts |

### PRODUCTION EXAMPLE 6

### Mixed Solution of Modified Starch and Acrylic Resin

Production of Acrylic Resin Solution 1

In a 1 L reactor equipped with a thermometer, thermostat, stirrer, condenser and dropping apparatus there was charged 333 parts of toluene, and the mixture was heated to 100° C. while stirring under a nitrogen atmosphere. Next, a solution of “mixture 2b” having the composition listed below was added dropwise over a period of 4 hours, and upon completion of the dropwise addition the mixture was aged at 100° C. for 1 hour to obtain acrylic resin solution 1 with a resin solid content of 60%. The hydroxyl value of the acrylic resin was 43 mgKOH/g.

“Mixture 2b” (*2)

| | |
|---|---|
| Styrene | 350 parts |
| Methyl methacrylate | 50 parts |
| n-Butyl acrylate | 50 parts |
| 2-Hydroxyethyl methacrylate | 50 parts |
| 2,2′-Azobis-2-methylbutyronitrile | 25 parts |

(*2): The monomer composition was the same as mixture 2 used in Production Example 2, but the type and amount of initiator were different.

Mixed Solution of Modified Starch and Acrylic Resin

In a 1 L reactor equipped with a thermometer, thermostat, stirrer and condenser there were charged 66 parts of acrylic resin solution 1 and 440 parts of butyl acetate, and the mixture was heated to 50° C. while stirring under a nitrogen atmosphere. Next, 160 parts of modified starch 1 was charged into the reactor while maintaining a temperature of 50° C., and then the temperature was raised to 100° C. and stirring was continued until complete dissolution of the charged modified starch 1 to obtain a mixed solution of acrylic resin 1 and modified starch 1 with a resin solid content of 30%.

### PRODUCTION EXAMPLE 7

### Polyurethane-modified Resin Solution 1 of Polymer-bonded Modified Starch Resin 2

Production of Polyurethane Resin Solution 1

In a 1 L reactor equipped with a thermometer, thermostat, stirrer, condenser and dropper there were charged 125 parts of toluene and 292 parts of hexamethylene diisocyanate, and the mixture was heated to 80° C. while stirring under a nitrogen atmosphere. Next, 208 parts of triethylene glycol was added dropwise over a period of 3 hours, and upon completion of the dropwise addition the mixture was aged at 80° C. for 30 minutes to prepare polyurethane resin solution 1 with a resin solid portion of 80%. The NCO value of the polyurethane resin was 58 mgNCO/g.

Polyurethane Modification of Polymer-bonded Modified Starch Resin 2

In a 1 L reactor equipped with a thermometer, thermostat, stirrer and condenser there were charged 41 parts of butyl acetate and 600 parts of the modified starch resin 2 solution with a resin solid content of 30% obtained in Production Example 2, and the mixture was heated to 100° C. while stirring under a nitrogen atmosphere. Next, 25 parts of polyurethane resin solution 1 with a resin solid content of 80% obtained previously was charged in and the mixture was stirred to uniformity, after which 0.04 part of dibutyltin dilaurate was added as a catalyst for reaction at 100° C. for 6 hours while stirring under a nitrogen atmosphere to obtain a polyurethane-modified resin solution of the polymer-bonded modified starch resin 2 with a solid content of 30%. The NCO value of the polyurethane-modified resin was less than 1.0 mgNCO/g.

### PRODUCTION EXAMPLE 8

### Polyurethane-modified Resin Solution 2 of Polymer-bonded Modified Starch Resin 5

Production of Polyurethane Resin Solution 2

In a 1 L reactor equipped with a thermometer, thermostat, stirrer, condenser and dropping apparatus there were charged 125 parts of toluene and 378 parts of isophorone diisocyanate, and the mixture was heated to 80° C. while stirring under a nitrogen atmosphere. Next, 122 parts of 1,4-butanediol was added dropwise over a period of 3 hours, and upon completion of the dropwise addition the mixture was aged at 80° C. for 30 minutes to prepare polyurethane resin solution 2 with a resin solid portion of 80%. The NCO value of the polyurethane resin was 57 mgNCO/g.

Polyurethane Modification of Polymer-bonded Modified Starch Resin 5

In a 1 L reactor equipped with a thermometer, thermostat, stirrer and condenser there were charged 41 parts of butyl acetate and 600 parts of the modified starch resin 5 solution with a resin solid content of 30% obtained in Production Example 5, and the mixture was heated to 100° C. while stirring under a nitrogen atmosphere. Next, 25 parts of polyurethane resin solution 2 with a resin solid content of 80% obtained previously was charged in and the mixture was stirred to uniformity, after which 0.04 part of dibutyltin dilaurate was added as a catalyst for reaction at 100° C. for 6 hours while stirring under a nitrogen atmosphere to obtain a polyurethane-modified resin solution 2 of the polymer-bonded modified starch resin 5 with a solid content of 30%. The NCO value of the polyurethane-modified resin was less than 1.0 mgNCO/g.

### PRODUCTION EXAMPLE 9

### Polyurethane-modified Resin Solution of Mixture of Modified Starch Resin and Acrylic Resin

Production of Acrylic Resin Solution 2

In a 1 L reactor equipped with a thermometer, thermostat, stirrer, condenser and dropping apparatus there was charged 333 parts of toluene, and the mixture was heated to 100° C. while stirring under a nitrogen atmosphere. Next, a solution of “mixture 1b” having the composition listed below was added dropwise over a period of 4 hours, and upon completion of the dropwise addition, the mixture was aged at 100° C. for 1 hour to obtain acrylic resin solution 2 with a resin solid content of 60%. The hydroxyl value of the acrylic resin was 0 mgKOH/g.

“Mixture 1b” (*3)

| | |
|---|---|
| Styrene | 320 parts |
| Methyl methacrylate | 40 parts |
| n-Butyl acrylate | 40 parts |
| 2,2′-Azobis-2-methylbutyronitrile | 20 parts |

(*3): The monomer composition was the same as mixture 1 used in Production Example 1, but the type and amount of initiator were different.

Urethane Modification of Mixed Solution of Modified Starch and Acrylic Resin

In a 1 L reactor equipped with a thermometer, thermostat, stirrer and condenser there were charged 66 parts of acrylic resin solution 2 and 435 parts of butyl acetate, and the mixture was heated to 50° C. while stirring under a nitrogen atmosphere. Next, 140 parts of modified starch 1 was charged into the reactor while maintaining a temperature of 50° C., after which the temperature was raised to 100° C. and the mixture was stirred until complete dissolution of the charged modified starch 1. After then charging 25 parts of the 80% polyurethane resin solution 2 into the mixture, 0.04 part of dibutyltin dilaurate was added as a catalyst and reaction was carried out at 100° C. for 6 hours while stirring under a nitrogen atmosphere to obtain a 30% solid polyurethane-modified resin mixture comprising the acrylic resin and modified starch. The NCO value of the resin mixture was less than 1.0 mgNCO/g.

Production of One-pack Type Starch-based Coating Composition

### EXAMPLE 1

To 333 parts of the modified starch resin 1 solution obtained in Production Example 1 (100 parts solid content) there were added 15 parts of HIGHFLAT F-713 (*4) (2 parts solid content), 42 parts of ALPASTE FX-440 (*5) (23 parts solid content), 3 parts HIGHCONC BLACK (*6), 1.5 parts of SYLYSIA 446 (*7) and 131 parts of methyl ethyl ketone, and the mixture was thoroughly mixed with a stirrer to obtain starch-based coating composition No.1 with a solid content of 25%.

### EXAMPLES 2-9 AND COMPARATIVE EXAMPLES 1-4

Starch-based coating compositions Nos. 2-13 were obtained by repeating the procedure of Example 1, except for using the modified starch resin solutions obtained in Production Examples 2-9 as binders instead of the modified starch resin solution obtained in Production Example 1, and changing the composition as shown in Table 1.

TABLE 1

| | | Example 1 | Example 2 | Example 3 | Example 4 | Example 5 | Example 6 | Example 7 |
|---|---|---|---|---|---|---|---|---|
| Starch-based coating | | No. 1 | No. 2 | No. 3 | No. 4 | No. 5 | No. 6 | No. 7 |
| Binder | Production | 333 (100) | | | | | | |
| | Example 1 | | | | | | | |
| | Production | | 333 (100) | | | | | |
| | Example 2 | | | | | | | |
| | Production | | | 333 (100) | | | | |
| | Example 3 | | | | | | | |
| | Production | | | | 333 (100) | | | |
| | Example 4 | | | | | | | |
| | Production | | | | | 333 (100) | | |
| | Example 5 | | | | | | | |
| | Production | | | | | | | |
| | Example 6 | | | | | | | |
| | Production | | | | | | 333 (100) | |
| | Example 7 | | | | | | | |
| | Production | | | | | | | 333 (100) |
| | Example 8 | | | | | | | |
| | Production | | | | | | | |
| | Example 9 | | | | | | | |

| | | | | | | | |
|---|---|---|---|---|---|---|---|
| Indust. nitro- | | | | | | | |
| cellulose BNC- | | | | | | | |
| HIG-2 (*8) | | | | | | | |
| CAB551-0.2 (*9) | | | | | | | |
| HIGHFLAT F-713 (*4) | 15 (2) | | | | | 15 (2) | |
| TFW-3000F (*10) | | 2 (2) | | | | | |
| ALPASTE FX-440 (*5) | 42 (23) | 42 (23) | 42 (23) | 42 (23) | 42 (23) | 42 (23) | 42 (23) |
| HIGHCONC BLACK (*6) | 3 | 3 | 3 | 3 | 3 | 3 | 3 |
| SILYSIA 446 (*7) | 1.5 | 1.5 | 1.5 | 1.5 | 1.5 | 1.5 | 1.5 |
| Methyl ethyl ketone | 124 | 136.5 | 130.5 | 130.5 | 130.5 | 124 | 130.5 |
| Coating solid content (%) | 25 | 25 | 25 | 25 | 25 | 25 | 25 |

| | | | | Comp. | Comp. | Comp. | Comp. |
|---|---|---|---|---|---|---|---|
| | | Example 8 | Example 9 | Ex. 1 | Ex. 2 | Ex. 3 | Ex. 4 |
| Starch-based coating | | No. 8 | No. 9 | No. 10 | No. 11 | No. 12 | No. 13 |
| Binder | Production | | | | | | |
| | Example 1 | | | | | | |
| | Production | 333 (100) | | | | | |
| | Example 2 | | | | | | |
| | Production | | | | | | |
| | Example 3 | | | | | | |
| | Production | | | | | | |
| | Example 4 | | | | | | |
| | Production | | | | | | |
| | Example 5 | | | | | | |
| | Production | | | 333 (100) | | 333 (100) | |
| | Example 6 | | | | | | |
| | Production | | 333 (100) | | | | |
| | Example 7 | | | | | | |
| | Production | | | | | | |
| | Example 8 | | | | | | |
| | Production | | | | 333 (100) | | 333 (100) |
| | Example 9 | | | | | | |

| | | | | | | |
|---|---|---|---|---|---|---|
| Indust. nitro- | 150 (30) | | | | 150 (30) | 150 (30) |
| cellulose BNC- | | | | | | |
| HIG-2 (*8) | | | | | | |
| CAB551-0.2 (*9) | | 150 (30) | | | | |
| HIGHFLAT F-713 (*4) | | | | 15 (2) | | |
| TFW-3000F (*10) | 2 (2) | | 2 (2) | | | |
| ALPASTE FX-440 (*5) | 42 (23) | 42 (23) | 42 (23) | 42 (23) | 42 (23) | 42 (23) |
| HIGHCONC BLACK (*6) | 3 | 3 | 3 | 3 | 3 | 3 |
| SILYSIA 446 (*7) | 1.5 | 1.5 | 1.5 | 1.5 | 1.5 | 1.5 |
| Methyl ethyl ketone | 106.5 | 100.5 | 136.5 | 124 | 100.5 | 100.5 |
| Coating solid content (%) | 25 | 25 | 25 | 25 | 25 | 25 |

( ) Values in parentheses represent solid portions.
(*4) Mineral turpentine suspension of polyethylene wax, product of Gifu Shellac Co., Ltd.
(*5) Aluminum paste, resin-coated type non-leafing aluminum, product of Toyo Aluminium, KK.
(*6) Coloring agent for solvent-type coatings, product of Yokohama Chemicals Co., Ltd.
(*7) Hydrous amorphous silicon dioxide (delustering agent), product of Fuji Silysia Chemical, Ltd.
(*8) Solution of propanol-wetted nitrocellulose in ethyl acetate, product of Bergerac NC, France.
(*9) Solution of cellulose acetate butyrate in ethyl acetate, product of Eastman Chemical Products
(*10) Fine powdered fluorine wax, product of Seishin Enterprise Co., Ltd.

Evaluation Results

Test sheets coated with the coatings of Examples 1-9 and Comparative Examples 1-4 were prepared and their film performance was evaluated. The evaluation results are shown in Table 2.

TABLE 2

| | Example | | | | | | | | | Comp. Example | | | |
|---|---|---|---|---|---|---|---|---|---|---|---|---|---|
| | 1 | 2 | 3 | 4 | 5 | 6 | 7 | 8 | 9 | 1 | 2 | 3 | 4 |
| Storage stability | VG | VG | G | G | G | VG | G | G | VG | F | F | F | F |
| Drying property | G | G | G | G | G | G | G | VG | VG | G | G | VG | VG |
| Finished appearance | G | G | G | G | G | G | G | G | G | G | G | G | G |
| Coated film appearance | G | G | G | G | G | G | G | G | G | G | G | G | G |
| Pencil hardness | H | H | H | H | H | H | H | H | H | H | H | H | H |
| Mar resistance | G | G | G | G | G | G | G | VG | VG | G | G | G | G |
| Adhesion | VG | VG | G | G | G | G | G | VG | G | VG | G | G | G |
| Impact resistance | G | G | G | G | G | G | G | G | G | G | G | G | G |
| Alkali resistance | G | G | G | G | G | G | G | G | G | G | G | G | G |
| Chemical resistance | G | G | G | G | G | G | G | VG | VG | F | G | G | G |
| Weather resistance | VG | VG | VG | VG | VG | VG | VG | VG | VG | VG | VG | VG | VG |

Evaluation Panels

Fabrication of Test Panels

The starch-based coating compositions No. 1-9 obtained in Examples 1-9 and the starch-based coating compositions No. 10-13 obtained in Comparative Examples 1-4 were used for spray coating to a dry film thickness of 8 μm on a NORYL SE1-701 panel (modified polyphenylene ether, product of Japan GE Plastics).

Then, an electric hot air drier was used for forced drying at 60° C. for 30 minutes, and then drying was carried out at room temperature (20° C.) for 7 days to fabricate test panels Nos. 1-9 and Nos. 10-13.

The fabricated test panels Nos. 1-13 were supplied for testing under the following test conditions.

Test Method

Storage Stability:

Each starch-based coating was stored in a 1 L sealed glass container, and the condition after storage for two weeks at 30° C. was evaluated on the following scale.
Very Good (VG): Coating stable without phase separation.
Good (G): Phase separation of coating observed, but was restored to uniform condition by light manual stirring with a spatula.
Fair (F): Notable phase separation of coating observed, but redispersion could be achieved by vigorous stirring with a rotary stirrer for 1 minute or longer.
Poor (P): Coating underwent complete separation and could not be redispersed.

Drying Property:

The paint was spray coated onto a NORYL SE1-701 panel (modified polyphenylene ether, product of Japan GE Plastics) to a dry film thickness of 8 μm and an electric hot air drier was used for forced drying at 60° C. for 30 minutes, after which the painted panel was immediately cooled to room temperature and the drying property of the surface based on touch was evaluated as follows.
Very Good (VG): Coated film was hard and smooth, and no imprint remained when pressed with the fingernail.
Good (G): Coated film was resilient but no imprint remained when pressed with the fingernail.
Fair (F): Coated film resilient and imprint remained when pressed with the fingernail.
Poor (P): Adhesive touch to coated film, imprint left after pressing with the fingernail, and fingerprint remained when pressed with pad of the finger.

Finished Appearance

The finished appearance of the coated surface of each test sheet was visually evaluated.
Good (G): Satisfactory finished appearance.
Fair (F): Reduction in finished appearance as demonstrated by at least loss of luster and flaking.
Poor (P): Notable reduction in finished appearance as demonstrated by at least loss of blushing and shrinking.

Coated Film Appearance

The appearance of the coated surface of each test sheet was visually evaluated.
Good (G): Satisfactory with uniform color tone over entire surface.
Fair (F): Soft color irregularities on coated surface.
Poor (P): Clearly distinguishable color irregularities on coated surface.

Pencil Hardness:

Following the procedure specified by JIS K5600-5-4(1999), the core of a pencil was placed against a test coated sheet surface at an angle of about 45°, and moved forward approximately 10 mm at a uniform speed while firmly pressing it against the test coated sheet surface without breaking the core. This procedure was repeated 5 times at different locations, and the hardness number of the pencil with the greatest hardness that did not tear the coated film was recorded as the pencil hardness.

Mar Resistance:

After pressing a commercially available name card against the coated film and gently rubbing, the degree of damage produced was judged.
Very Good (VG): Absolutely no damage.
Good (G): Virtually no damage.
Fair (F): Light marring.
Poor (P): Severe marring.

Adhesion:

Following the procedure specified by JIS K5600-5-6(1990), a 100-square grid at 1 mm×1 mm was formed in the coated film and adhesive tape was attached to the surface, and after abruptly peeling it off, the number of squares of the coated film remaining on the surface was evaluated.
Very Good (VG): Number of squares remaining/total number=100/100.
Good (G): Number of squares remaining/total number=99/100.
Fair (F): Number of squares remaining/total number=90-98/100.
Poor (P): Number of squares remaining/total number=<89/100.

Impact Resistance:

This was evaluated with a DuPont impact resistance tester (½-inch striker, 500 g×50 cm).
Good (G): No cracking observed in coated film after single impact.
Poor (P): Notable cracking observed in coated film after single impact.

Alkali Resistance:

After dropwise addition of 0.5 mL of a 1% sodium hydroxide aqueous solution onto the coated film surface of a test panel, it was allowed to stand for 24 hours in an atmosphere at 20° C., 65% RH, and then the coated surface was wiped with gauze and its outer appearance visually evaluated.
Good (G): Absolutely no abnormalities on coated film surface.
Fair (F): Coloration (whitening) observed on coated film surface.
Poor (P): Notable coloration (whitening) observed on coated film surface.

Chemical Resistance:

Two sheets of filter paper were placed on each coated test sheet, and the filter paper sheets were wetted by dropwise addition of 78% ethanol and 2% formalin using a dropper. The dropwise addition with the dropper was carried out 5 times at one hour intervals, and then after two hours the filter paper was removed and the coated film surface was observed and visually evaluated.
Very Good (VG): Absolutely no abnormalities such as blistering or peeling.
Good (G): Virtually no clearly visible abnormalities such as blistering or peeling.
Fair (F): Abnormalities such as slight blistering or peeling visible.
Poor (P): Dissolution of coated film.

Weather Resistance:

The luster of each multilayer coating was measured using a carbon arc lamp-type accelerated weather resistance testing sunshine weather-o-meter according to JIS H8602-5.12(1992) (water spraying time: 12 minutes, black panel temperature: 60° C.), and the time necessary for the gloss retention to fall below 80% with respect to the gloss before the exposure test was measured.
Very Good (VG): More than 300 hours until gloss retention fell below 80%.
Good (G): At least 200 hours and less than 300 hours until gloss retention fell below 80%.
Fair (F): At least 100 hours and less than 200 hours until gloss retention fell below 80%.
Poor (P): Less than 100 hours until gloss retention fell below 80%.

According to the invention it is possible to obtain starch-based coating compositions with excellent storage stability as one-pack lacquer type coatings, in order to yield coated films with superior finished appearance, hardness, adhesion, chemical resistance and alkali resistance.

1. A starch-based coating composition characterized by using as the binder a resin (A) obtained by bonding a vinyl polymer onto starch and/or modified starch by graft polymerization.

2. A starch-based coating composition characterized by using as the binder a resin (C) prepared by addition reaction of an isocyanate group-containing product (B) obtained by reacting a polyisocyanate compound (b1) with a polyhydric alcohol (b2), with a resin (A) obtained by bonding a vinyl polymer onto starch and/or modified starch by graft polymerization.

3. A starch-based coating composition according to claim 1 or 2, wherein the resin (A) is a resin in which the vinyl polymer is bonded by graft polymerization of an unsaturated monomer mixture comprising 1-90 mass % of an aromatic monomer onto starch and/or modified starch.

4. A starch-based coating composition according to claim 3, wherein the resin (A) is a resin in which the vinyl polymer is bonded by graft polymerization of an unsaturated monomer mixture comprising 1-90 mass % of an aromatic monomer, 1-50 mass % of a hydroxyl-containing monomer and 0-98% of another monomer.

5. A starch-based coating composition according to claim 1 or 2, wherein the starch-based coating composition is dissolved or dispersed in an organic solvent-based medium.

6. A starch-based coating composition according to claim 1 or 2, which further comprises a biodegradable resin.

7. A starch-based coating composition according to claim 6, wherein the biodegradable resin is modified nitrocellulose and/or cellulose.

8. A starch-based coating composition according to claim 1 or 2, which further comprises a wax.

9. A coated article which is coated with a starch-based coating composition according to claim 1 or 2.
